(19) United States
(12) Patent Application Publication
(10) Pub. No.: US 2007/0143410 A1
(43) Pub. Date: Jun. 21, 2007

(54) System and method for defining and translating chat abbreviations

(75) Inventors: Maureen E. Kraft, Hudson, MA (US); Jessica J. Brown, Apex, NC (US); Michael D. Facemire, Cary, NC (US); Michael Wanderski, Durham, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/303,276

(22) Filed: Dec. 16, 2005

(51) Int. Cl. G06F 15/16

(52) U.S. Cl. 709/206

(57) ABSTRACT

A system and method for defining and translating chat abbreviations. A system is provided for modifying messages in real-time based on an identity of an intended recipient, including: a rules database that includes rules for translating chat abbreviations based on the identity of the intended recipient; a system for identifying a chat abbreviation in a message; and a rules engine that associates a set of rules from the rules database with the intended recipient and applies the set of rules to the chat abbreviation identified in the message. Also included is a system for providing composite definitions of chat abbreviations in a multi-lingual chat session based upon a locale and a language of a sender and the intended recipient.

### FIELD OF THE INVENTION

The invention relates generally to messaging systems, and more particularly, to a system and method for defining and translating chat abbreviations in a messaging environment.

### BACKGROUND OF THE INVENTION

Instant messaging (IM) has become a popular form of electronic communication, commonly referred to as “chat.” Various platforms exist to support IM, including Internet based applications such as AOL®IM, MSN MESSENGER®, etc., and wireless based applications such as cell phone text messaging. To reduce key strokes, chat abbreviations have been developed and incorporated into the chat vernacular, including text strings such as ttyl (talk to you later), ttfn (ta ta for now), bibi (bye-bye), ur (you are?), etc. These are just a few of the many recognizable chat abbreviations that are common chat lingo used by avid IM'ers.

The use of chat abbreviations however has a number of drawbacks. First and foremost is the fact that a user may not know what a chat abbreviation stands for. Secondly, chat abbreviations are language specific in that their meaning does often not translate well between languages. Accordingly, what may be an obvious abbreviation in English, such as “ur,” may be completely unrecognizable in another language. Furthermore, chat abbreviations may be subject to several meanings, and be interpreted differently by different audiences. Moreover, when chatting with multiple parties (i.e., an N-way chat), certain terms may not be appropriate for some of the audience (e.g., a customer), but be alright for others (e.g., a co-worker).

Currently, chat dictionaries exist to define different chat abbreviations. However, existing dictionaries have certain limitations that restrict their application in certain environments, such as within a chat community that heavily uses and is constantly creating new abbreviations. Moreover, definitions provided by current chat dictionaries cannot be integrated into assistive technologies, such as those used for people with visual impairments. Finally, no technology exists that allows users to translate chat abbreviations and terms to different languages or translate based on the intended audience. Accordingly, a need exists for more enhanced chat abbreviation definition and translation features within a messaging program.

### SUMMARY OF THE INVENTION

The present invention addresses the above-mentioned problems, as well as others, by providing a system and method for implementing a messaging system that includes enhanced definition and translation features relating to chat abbreviations.

In a first aspect, the invention provides a messaging system having a textual translation system for modifying messages in real-time based on an identity of an intended recipient, comprising: a rules database that includes rules for translating chat abbreviations based on the identity of the intended recipient; a system for identifying a chat abbreviation in a message; and a rules engine that associates a set of rules from the rules database with the intended recipient and applies the set of rules to the chat abbreviation identified in the message.

In a second aspect, the invention provides a computer program product stored on a computer usable medium for modifying messages in real-time for a messaging system based on an identity of an intended recipient, wherein the computer program product comprises: program code configured for accessing a rules database that includes rules for translating chat abbreviations based on the identity of the intended recipient; program code configured for identifying a chat abbreviation contained in a message; and program code configured for associating a set of rules from the rules database with the intended recipient and applying the set of rules to the chat abbreviation identified in the message.

In a third aspect, the invention provides a method for modifying chat abbreviations in real-time for a messaging system based on an identity of an intended recipient, comprising: identifying a chat abbreviation contained in a message; associating a rule from a rules database with the intended recipient; and translating the chat abbreviation identified in the message based on the rule.

In a fourth aspect, the invention provides a method for deploying a messaging application in which chat abbreviations are modified in real-time based on an identity of an intended recipient, comprising: providing a computer infrastructure being operable to: identify a chat abbreviation contained in a message; associate a rule from a rules database with the intended recipient; and translate the chat abbreviation identified in the message based on the rule.

In a fifth aspect, the invention provides a messaging system that communicates messages within a chat session, comprising: a definitions database that includes definitions for chat abbreviations; a system for obtaining a definition for a chat abbreviation contained in a message from the definitions database without pausing the chat session; and an assistive technology system that provides the definition of the chat abbreviation to an end-user within an assistive technology framework.

In addition, the invention includes a system for providing composite definitions of chat abbreviations in a multi-lingual chat session based upon a locale and a language of a sender and the intended recipient.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a messaging system in accordance with an embodiment of the present invention.

FIG. 2 depicts a textual translator in accordance with an embodiment of the present invention.

### DETAILED DESCRIPTION OF THE INVENTION

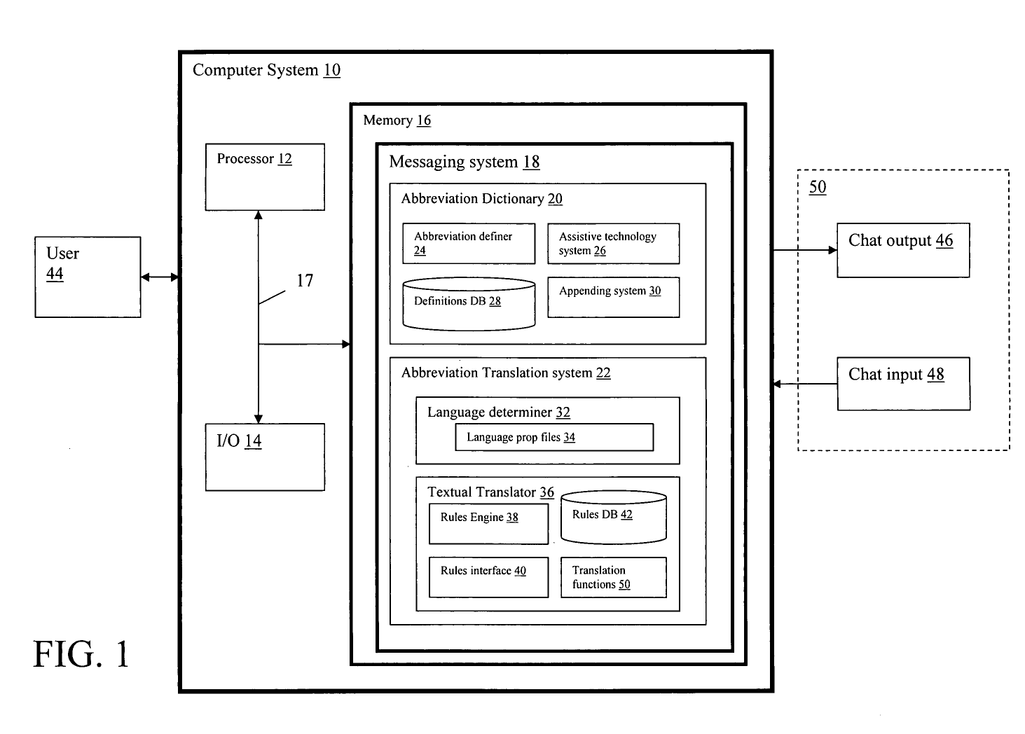

Referring now to drawings, FIG. 1 depicts a computer system 10 having a messaging system 18 that allows a user 44 to engage in a bi-directional communication or “chat” session with one or more remote users over a communication network 50. Messaging system 18 may comprise any type of system capable of exchanging chat-based messages, e.g., an IM system, a text messaging system, a web blog, wikis, email, RSS, etc. Network 50 may comprise any type of communication network, e.g., the Internet, a cellular network, wireless, etc. In the illustrative embodiment shown in FIG. 1, messaging system 18 receives messages (e.g., chat input 48) from one or more remote users and outputs messages (e.g., chat output 46) generated by user 44 to one or more remote users. In general, messaging system 18 includes a user interface (not shown) that allows user 44 to display and enter messages. Such interfaces are well known in the art, and may for example include a first window in which text may be entered and a second window that displays strings of messages communicated between the users. Note that the embodiments described herein are for illustrative purposes only, and any known methodologies may be utilized to implement the processes, systems and features described herein.

As noted above, users of messaging systems 18, such as IM, text messaging, etc., commonly use text strings made up of abbreviations (e.g., ttyl, ttfn, etc.), chat terms (e.g., ˆ5) and objects (e.g., a smiley face) as to reduce keystrokes or emphasize some point. For the purpose of this disclosure, the term “abbreviation” may include any type of chat acronym, term, object, text string, etc., utilized within a message that is subject to interpretation or definition. Additionally, note that the terms “chat” and “message” are used interchangeably throughout this document.

To enhance the use of abbreviations in a messaging environment, messaging system 18 includes: (1) an abbreviation dictionary 20 that includes enhanced features for defining the meaning of abbreviations used in a messaging session; and (2) an abbreviation translation system 22 that includes a language determiner 32 for translating abbreviations between different languages, and a textual translator 36 for translating abbreviations based on one or more translation functions 50 that apply predefined translations rules for an intended recipient.

Abbreviation Dictionary

Abbreviation dictionary 20 includes an abbreviation definer 24 that allows a user 44 to obtain a definition of an abbreviation, by for example passing the mouse pointer over the abbreviation. Using abbreviation definer 24, the user 44 is not required to leave the chat session to obtain the definition. To obtain the definition, abbreviation definer 24 accesses a definitions database 28, which includes definitions for a set of abbreviations. Enhancements to the abbreviation dictionary include an assistive technology system 26 and an appending system 30. Assistive technology system 26 provides a mechanism through which assistive technologies, such as those used for people with impaired vision, can utilize the abbreviation dictionary 20.

One common type of assistive technology framework involves a screen reader, such as that provided by Freedom Scientifics' JAWS® system, which reads textual words aloud for the visually impaired. One of the limitations of using such a system in a messaging environment is that chat abbreviations are read letter by letter, such as “b” “4” “n”, which is an abbreviation for “bye for now.” In an assistive technology framework, assistive technology system 26 utilizes the abbreviation definer 24 to provide the definition of the abbreviation to the assistive technology (e.g., JAWS), such that the visually impaired user hears the definition of the abbreviation instead of the letters. Thus, by exposing the real meaning of these abbreviations to the assistive technology framework, the visually impaired user's chat experience is enhanced. By defining the abbreviation and exposing this definition in, e.g., tooltip, alternate or accessibility text, the system provides additional information to the screen reader on the message being conveyed.

Appending system 30 provides a mechanism through which abbreviation definitions can be added (or deleted) from the definitions database 28. This may be done, e.g., using a right click of the mouse to open a dialog window for adding a definition. Thus, for chat communities that are developing and implementing their own abbreviation vernacular, appending system 30 provides a mechanism to easily maintain a definitions database 28.

Additionally, abbreviation definer 24 can be used by one or more of the translation functions 50 described below.

Abbreviation Translation System

As noted above, abbreviation translation system 22 includes a language determiner 32 and a textual translator 36. Language determiner 32 provides a system for providing composite definitions in a multilingual chat session based on the locale and language of the recipient. In one illustrative embodiment, the handling of chat abbreviations during multi-lingual conversations can be implemented as follows. First, definitions database 28 is provided that includes definitions for each of a plurality of different languages. When a chat input 48 is received from a sender, the sending user's locale would be determined by the language determiner 32, e.g. by checking a preset language code for both the sender and recipient of the chat input 48. When an abbreviation is identified in the chat input 48, definitions database 28 is searched to find a translation of the abbreviation in the recipient's language. In addition, the definitions database 28 within the abbreviation dictionary 20 is checked to find a translation of the abbreviation in the sender's language. The language determiner 32 then builds a composite definition of the chat term which includes translations of the term in both the recipient's and sender's languages.

In an illustrative embodiment, messaging system 18 may include language properties files 34 for a plurality of languages. If the language determiner 32 can determine the locale of both the sender and receiver, and a chat translation exists for both languages, then a composite definition may be displayed to the user. Accordingly, if a user in the United States was chatting with a family member in Germany and typed “ttyl”, and a definition of the chat term existed for both English and German, a composite definition of “talk to you later, bis spatter” would be displayed.

If a language code is not set or a definition for the abbreviation is not found in the sender's dictionary, the abbreviation's definition is looked up in the dictionary for the receiver's locale. If the abbreviation is not found in the definitions database 28 of the sender's locale, a default chat abbreviation language file, e.g., English, could be used. Thus, if two users whose language is other than English, but who are chatting, send an English chat abbreviation, they would expect to see the English definitions of their chat abbreviations.

To implement definitions database 28 having multilingual chat dictionaries, properties files 34 are provided for defining the meaning of the chat term in multiple languages. For instance, properties files 34 may use a “key=value” pair mapping of keywords to their values. Typically, these key value pairs are used to translate an application into multiple languages, simply by translating the resources defined in the properties file. The keys used to lookup the values are typically static variables predefined by a developer.

Thus, properties files 34 to create a chat dictionary can be implemented by specifying “chat abbreviation=definition” in place of the “key=value” pairs where the chat abbreviation is dynamically created by the value that the chat user types in. This value can then be converted to a set case and appropriate encoding, and then used as a key to look up the definition of the abbreviation for the given language. Since properties files are required to be in ASCII, any non-ASCII strings will need to be encoded, e.g., in Unicode. For example, assume that Unicode character \u201c is a chat abbreviation in Chinese and its meaning has the value that follows:
\u201c=\u76ee\u5f55\u64cd\u4f5c\u5931\u8d25\u3002\u539f\u56e0\uff1a\u201c
Note that in order for these dictionaries to be created, the properties files 34 would need to be initially created in their native language and then converted using appropriate tools.

In a typical embodiment, properties files 34 are written in ASCII, which include the range of characters we are familiar with in English, A-Z, a-z, 0-9, (,./, etc. In order to represent characters that fall outside the ASCII range, Unicode characters may be used. During the translation process, translators are given English properties files which they translate into their native language. These file are in turn run through a utility which converts the non-ASCII characters into a Unicode encoded character. Unicode characters are hexadecimal representations of characters and can be represented using ASCII. \u at the start of the character string states that the character that follows is in Unicode format. The four digits following \u is the hexadecimal value that maps to the character being displayed on the screen. Thus, a typical key created using ASCII, e.g.,
“FIRST_TIME_USER_TEXT=Welcome to Sametime Messaging”
may be used from language to language. Only the value is translated and converted to Unicode. In order to use properties files 34 to support the translation of chat terms, the key would become the chat term and the value its translation, e.g., ttyl=talk to you later. However, if a user is chatting using a non-ASCII system, e.g., Chinese, and the user has non-ASCII chat terms for which they would like the translation displayed, both the key and the value need to be represented by Unicode since Chinese characters fall out of the range of simple ASCII.

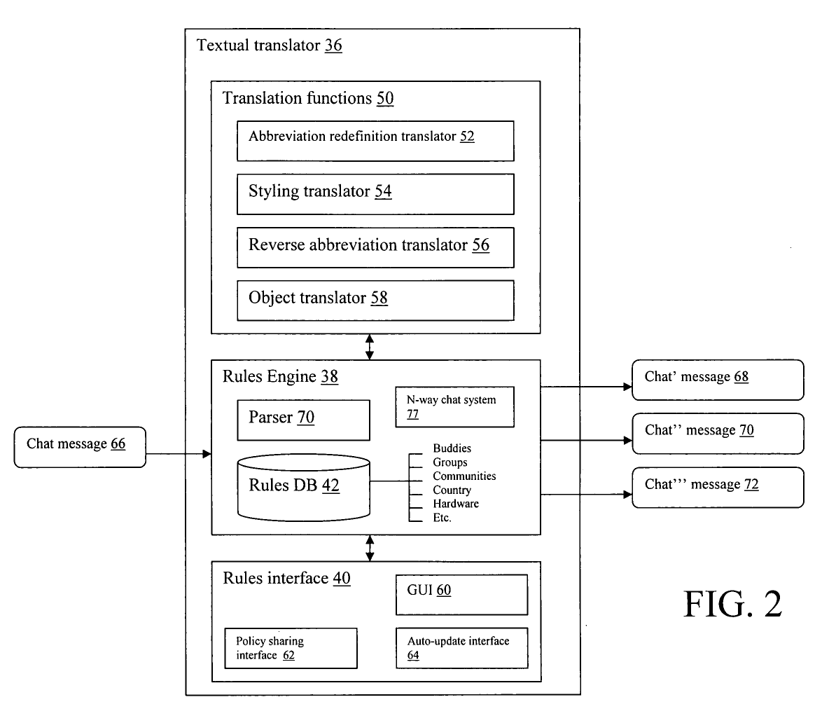

Textual translator 36 provides a mechanism for dynamically tailoring a conversation to conform to a set of policies in real-time, associated with the person sending the chat message and the audience the message is intending to address. To implement this, textual translator 36 includes a set of translation functions 50, a rules engine 38, a rules interface 40 and a rules database 42. Each of these features is shown in greater detail in FIG. 2.

As shown in FIG. 2, when a user enters a chat message 66, a rules engine 38 parses the message 66 to identify any chat abbreviations contained in the message 66, e.g., using a parser 70 or any other mechanism. Based on the identity of the intended recipient and any identified abbreviations, rules engine 38 checks a rules database 42 to determine if any of the abbreviations should be modified or redefined by one or more of the translation functions 50. This may be accomplished by first identifying one or more (i.e., a set of) rules that are associated with the intended recipient/identified chat abbreviation, and then applying the set of rules to the chat abbreviation. The identity of the recipient may be determined, for instance, as a person listed as a buddy, as a member of a chat group, as a member of a chat community, as a person in a specific country or geographic area, as a person using a predetermined type of hardware, etc. Thus, in response to the applicable rules, a chat message 66 may be translated to chat′ message 68 for a first intended recipient, chat″ message 68 for a second intended recipient, and chat′″ message 70 for a third intended recipient.

As shown, textual translator 36 includes a set of illustrative translation functions 50 that include an abbreviation redefinition translator 52, a styling translator 54, a reverse abbreviation translator 56 and an object translator 58. Each of these functions 50 are used to dynamically translate chat abbreviations in response to one or more rules applied by rules engine 38.

Abbreviation redefinition translator 52 provides a mechanism for automatically redefining abbreviations based on the identity of the intended recipient. In a simple case, abbreviation redefinition translator 52 may simply look up the standard definition of a chat abbreviation. For example, user 44 may enter a chat message 66 containing the abbreviation “ttyl” meaning “talk to you later,” which is intended for the user's grandmother, who may or may not know what “ttyl” means. Assuming a rule in the rules database 42 was established that the grandmother required abbreviation translations, abbreviation translator 52 would automatically generate a modified chat′ message 68 for the grandmother, which would include the translated abbreviation “talk to you later.” In other instances, the same message may be redefined for a buddy, in which the abbreviation “ttyl” may be redefined to “later dude.”

To implement this functionality, an abbreviation dictionary 20, such as that described above, may be implemented in which chat abbreviations have multiple definitions. Based on the intended recipient, textual translator 36 would select that appropriate definition and perform the translation in real-time chat conversations. Thus, in addition to simply providing helpful translations, this function can dynamically cleanse typically colloquial conversations (e.g., a conversation with a boss) into a more suitable tone. For example, if user 44 accidentally sent a chat message 66 containing the phrase “you've got to be baggin me” to the user's boss, rules engine 38 could automatically identify baggin as a chat abbreviation, and check to see if a special rule was in place for individuals of higher authority. If so, the rules engine 38 then might dynamically change “baggin” to “kidding” so that the chat message 68 now reads “you have got to be kidding me.”

Additionally, policy-based rules may be associated with groups or communities (or any environmental influence). For example, chatting features in a sales team-space may be translated into terms relevant for sales professionals. Thus, policies can be defined to adaptively translate conversation for each person involved. For example, in an accounting team-space, “swag” can mean “scientific wild aim guess” to accountants, but it could mean something completely different to someone in a developers team-space where the term “swag” means “semantic web agreement group.” Thus, the real-time translation is tailored to the audience involved. Moreover, rules engine 38 can be utilized to express persona based on the social influences of the audience involved. For example, communications with a good buddy might translate “swag” to “scientific wild amateur guess.” Consequently, communities (e.g., a workplace) can therefore adaptively learn how conversations can be translated over time. Terms that are used repeatedly, but do not grammatically translate to recognized vernacular, can be adapted and associated with a real-time translation process.

The real-time capabilities of textual translator 36 can also be applied to a community (N-way) chat (e.g., in a workplace team-space) in which each person in the conversation may receive their own individual version of the chat based on defined rules. To implement this, rules engine includes a N-way chat system 77 to generate multiple versions of an inputted chat message 66. For instance, in an N-way chat in which a chat message 66 was intended for three different recipients, the chat message 66 could be translated into three different versions, chat′ message 68, chat″ message 70, and chat′″ message 72. For example, if a user in an accounting community N-way chat used the term “swag,” an accountant might get no translation, friends would get “scientific wild amateur guess,” and a boss (or unknown person) would get the cleansed version, “scientific wild astronomical guess” to avoid issues with the profane language used.

In addition, a styling translator 54 could be implemented to automatically apply styling to a text string, such as highlighting chat abbreviations in bolded red for emphasis. Styling is typically done in chat messages to change the tone and inflections of words depending on the person being addressing. Thus, styling translator 54 allows the user to implement rules to apply this social behavior automatically and in real-time based on the intended audience.

Reverse abbreviation translator 56 is used to reverse the typical abbreviation expansion/lookup process to make chat more easily understood. For example, if a user is making outgoing communications to a recipient using a mobile device having a small display, the user may enter the message from a personal computer as “see you later,” but translate it for the mobile device to “cu 18r.” Note that this, as well as all of the rules, could be implemented either by the sending party or by the receiving party. To implement reverse abbreviation translator 56, parser 70 could be configured to look for commonly used phrases in the chat message 66, as opposed to chat abbreviations.

Object translator 58 is utilized to translate object representations, which comprises, e.g., non-textual based chat. For example, the commonly used ASCII frown “:(” might translate to a typical red frowning face icon in English, but not in other languages where red is taboo and offensive. In those cultures, object translator 58 would translate to something less offensive. Of course, all the adaptations described above could be applied here as well to personalize the expression to the various audiences.

Rules interface 40 provides various interfaces through which rules in the rules database 42 can be established. Rules interface 40 includes a graphical user interface (GUI) 60 that, e.g., allows a user to create, modify and delete rules; a policy sharing interface 62 that allows rules to be shared among different users, e.g., within a community; and an auto-update interface 64 automatically populating dictionaries and databases with updated rules and definitions.

In general, the computer system 10 shown in FIG. 1 may comprise any type of computing device, e.g., a personal computer, a phone, a handheld device, etc. Moreover, computer system 10 could be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server.

Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network 50 such as the Internet, a local area network (LAN), a wide area network (WAN), a virtual private network (VPN), a cellular network, etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising an abbreviation dictionary 20 and/or abbreviation translation system 22 could be created, maintained and/or deployed by a service provider that offers the functions described herein for customers. That is, a service provider could offer to provide a plug-in or remotely accessible definition/translation service as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A messaging system having a textual translation system for modifying messages in real-time based on an identity of an intended recipient, comprising:
a rules database that includes rules for translating chat abbreviations based on the identity of the intended recipient;
a system for identifying a chat abbreviation in a message; and
a rules engine that associates a set of rules from the rules database with the intended recipient and applies the set of rules to the chat abbreviation identified in the message.

2. The messaging system of claim 1, wherein the intended recipient is selected from the group consisting of: a buddy, a member of a defined group, a member of a defined community, a resident of a geographic area, and a user of a predetermined type of hardware.

3. The messaging system of claim 1, wherein the system for identifying the chat abbreviation comprises a parser.

4. The messaging system of claim 1, wherein the rules engine redefines the chat abbreviation based on the intended recipient.

5. The messaging system of claim 1, wherein the rules engine changes a styling of the chat abbreviation based on the intended recipient.

6. The messaging system of claim 1, further comprising a reverse abbreviation translation system that identifies a common phrase in the message and converts the common phrase to a chat abbreviation.

7. The messaging system of claim 1, wherein the rules engine modifies a chat object based on the intended recipient.

8. The messaging system of claim 1, wherein the textual translator includes an N-way chat system for modifying a chat message to create a plurality of modified chat messages, wherein each modified chat message is uniquely tailored for the intended recipient.

9. The messaging system of claim 1, further comprising a rules interface that includes a user interface, a policy sharing interface, and an auto-update interface.

10. The messaging system of claim 1, further comprising a language determiner that provides a composite definition of chat abbreviations in a multi-lingual chat session based upon a locale and a language of a sender and the intended recipient.

11. A computer program product stored on a computer usable medium for modifying messages in real-time for a messaging system based on an identity of an intended recipient, wherein the computer program product comprises:
program code configured for accessing a rules database that includes rules for translating chat abbreviations based on the identity of the intended recipient;
program code configured for identifying a chat abbreviation contained in a message; and
program code configured for associating a set of rules from the rules database with the intended recipient and applying the set of rules to the chat abbreviation identified in the message.

12. The program product of claim 10, wherein the intended recipient is selected from the group consisting of: a buddy, a member of a defined group, a member of a defined community, a resident of a geographic area, and a user of a predetermined type of hardware.

13. The program product of claim 10, wherein the set of rules performs a function selected from the group consisting of: redefining the chat abbreviation based on the intended recipient; changing a styling of the chat abbreviation based on the intended recipient; and modifying a chat object based on the intended recipient.

14. The program product of claim 10, further comprising program code configured for identifying a common phrase in the message and converting the common phrase to a chat abbreviation.

15. The program product of claim 10, further comprising program code configured for providing an N-way chat in which a chat message is modified to create a plurality of modified chat messages, wherein each modified chat message is uniquely tailored for an intended recipient.

16. The program product of claim 10, further comprising program code configured for providing a user interface, a policy sharing interface, and an auto-update interface.

17. The program product of claim 10, further comprising program code configured for providing composite definitions of chat abbreviations across different languages being used by chat participants.

18. A method for modifying chat abbreviations in real-time for a messaging system based on an identity of an intended recipient, comprising:
identifying a chat abbreviation contained in a message;
associating a rule from a rules database with the intended recipient; and
translating the chat abbreviation identified in the message based on the rule.

19. The method of claim 18, wherein the intended recipient is selected from the group consisting of: a buddy, a member of a defined group, a member of a defined community, a resident of a geographic area, and a user of a predetermined type of hardware.

20. The method of claim 18, wherein rule performs a function selected from the group consisting of: redefining the chat abbreviation based on the intended recipient; changing a styling of the chat abbreviation based on the intended recipient; and modifying a chat object based on the intended recipient.

21. The method of claim 18, further comprising the further step of identifying a common phrase in the message and converting the common phrase to a chat abbreviation.

22. The method of claim 18, further comprising the step of providing an N-way chat in which a chat message is modified to create a plurality of modified chat messages, wherein each modified chat message is uniquely tailored for an intended recipient.

23. The method of claim 18, further comprising the step of updating the rules database via an interface selected from the group consisting of: a user interface, a policy sharing interface, and an auto-update interface.

24. The method of claim 18, further comprising the step of providing composite chat translations across different languages used in a chat session.

25. A method for deploying a messaging application in which chat abbreviations are modified in real-time based on an identity of an intended recipient, comprising:
providing a computer infrastructure being operable to:
identify a chat abbreviation contained in a message;
associate a rule from a rules database with the intended recipient; and
translate the chat abbreviation identified in the message based on the rule.

26. A messaging system that communicates messages within a chat session, comprising:
a definitions database that includes definitions for chat abbreviations;
a system for obtaining a definition for a chat abbreviation contained in a message from the definitions database without pausing the chat session; and
an assistive technology system that provides the definition of the chat abbreviation to an end-user in an assistive technology framework.

27. The messaging system of claim 26, wherein the assistive technology system comprises a screen reader.
